(19) United States
(12) Patent Application Publication
(10) Pub. No.: US 2014/0157098 A1
(43) Pub. Date: Jun. 5, 2014

(54) SYSTEM FOR THE INTERACTION AMONG SPREADSHEETS OVER NETWORKS

(71) Applicant: Massimo Maresca, Genova (IT)

(72) Inventor: Massimo Maresca, Genova (IT)

(21) Appl. No.: 14/094,708

(22) Filed: Dec. 2, 2013

(30) Foreign Application Priority Data
Dec. 4, 2012 (IT) GE2012A000114

(51) Int. Cl. G06F 17/24

(52) U.S. Cl. CPC G06F 17/246
USPC 715/219; 715/212; 715/220

(57) ABSTRACT

By means of this system, the interaction among spreadsheets is completely integrated within the Spreadsheet Management System whereas it does not require the usage of other tools supporting the communication over a network such as web browsers, mailers, and file transfer clients. The interaction is implemented by the Enabling Platform, integrated within the Spreadsheet Management System, and by the Service Platform, located on a computing system that can be reached over the Internet or on a different private network making the Service Platform's intervention not visible to users.

### CROSS REFERENCE TO RELATED APPLICATIONS

The present application claims the priority benefit of Italian patent application number GE2012A000114, filed Dec. 4, 2012, and titled “Sistema di interazione tra fogli elettronici in rete”, the disclosure of which is hereby incorporated by reference.

### FIELD OF THE INVENTION

The present invention relates generally to data management and more particularly to the interaction of spreadsheets over networks.

### SUMMARY OF THE INVENTION

This system allows the realization of a service for the sending/reception of cells/tables, much efficient and less intricate compared to the traditional e-mail systems. In this system the sent/received items are not general purpose messages with attached spreadsheet files—as it usually happens with e-mail messages—but single spreadsheet cells/tables; in practice the tool used to send/receive cells/tables is the spreadsheet management system empowered with the Enabling Platform.

This system allows the creation of connections among cells/tables belonging to different spreadsheets owned by potentially different users with no constraint on the spreadsheets' File Management Systems nor on the users' administrative domains where each user has the possibility of enabling the access to other users on cells/tables belonging to his/her spreadsheets instead of enabling/disabling the access only to an entire spreadsheet—as allowed by the File Management Systems—as well as the possibility of creating connections among cells/tables belonging to other users who have previously granted him/her access to their own spreadsheets.

This system allows to control the data update for connections among spreadsheets belonging to different users. Such kind of control stems from the possibility for the user who granted access to his/her cells/tables to configure the Enabling Platform in such a way that data updates are not propagated outside the spreadsheet until the user, by means of a specific command, enables the visibility of such data updates. The user who granted access to his/her cells/tables can also configure the Enabling Platform in such a way that data updates are propagated outside the spreadsheet immediately.

This system allows spreadsheet users to provide to a set of recipient users tables which are partially precompiled (i.e., some cells are empty) whereas some cells contain values and some other cells contain formulas in such a way the recipient users can install these tables in their own spreadsheets, fill out the empty cells (or a subset of them) and to make automatically available the filled tables to the user who provided the precompiled table.

This system allows a spreadsheet user to link single rows of a table to which he/she granted access to through a value located in correspondence of a given column (i.e., of a specific cell) in such a way that the user can link a specific row (i.e., the one containing the specific value on the given column) even if the row changes its position in the table belonging to the spreadsheet for which the access has been granted.

This system allows spreadsheet users to make available computing models to other users, e.g., user B, for utilization only, without making them aware of the computing models' inner structure. In order to do so the user A who intends to allow the computing model's usage to other users makes available a partially precompiled table which will be filled out by user B who will insert the configuration parameters; user A grants access to the table/tables containing the results of the computing model's recalculation for user B who can use such results to perform his/her own processing operations in his/her own spreadsheet.

### BRIEF DESCRIPTION OF THE DRAWINGS

FIG. 1 is an illustration of some of the various exemplary systems and methods described herein.

### DETAILED DESCRIPTION

The present invention is concerned with a system that supports the interaction among spreadsheets over a network, for example a private network or the Internet.

As it is known in computer systems there exist programs that allow to create, modify and in general manage spreadsheets that include tables and/or cells of data connected to each other. Microsoft Excel™ is the best known example of such Spreadsheet Management Systems.

One of the main problems that the users of these systems have is the impossibility to exchange data directly. If two different users want to exchange data they can do it either through electronic mail or through file transfer. Using the electronic mail, which is by far the most commonly used system, the user that intends to send a cell/table of a spreadsheet to another uses copies and saves such a cell/table in a temporary spreadsheet, activates the electronic mail system, creates a message, attaches the temporary spreadsheet to such a message and sends the message to the other user. The destination user activates the electronic mail system, receives the message, opens the spreadsheet attached to the message and copies the cell/table into the destination spreadsheet. As it intuitively appears the mechanism is rather complicate, is neither immediate nor direct and involves a large number of actions thus creating the possibility of errors.

If on the contrary two users want to create links between cells/tables belonging to their spreadsheets, where each spreadsheet is owned by a different user, the following conditions must be fulfilled:

1. User A who intends to create a link from a cell/table of a spreadsheet of User B to a cell/table of one of his spreadsheets must be authorized to access the entire spreadsheet of user B;

2. The two users must belong to the same administrative domain;

3. The spreadsheets of the two users must belong to the same File Management System.

The objective of the present invention is therefore the implementation of a spreadsheet interaction system which allows connecting cells/tables of different spreadsheets, with no constraint on the localization of the two users and with no constraint on the association of the users to any administrative domain, thus supporting a set of value added services that integrate the spreadsheet management tools with the networks.

Such services are made available by an interaction system according to what claimed in claim 1 and in the successive Claims.

The system for the interaction among spreadsheet users subject of the present invention is controlled by a software platform integrated with the Spreadsheet Management System. Such a platform enriches the functionalities of the Spreadsheet Management System and does not requires that the users adopt other tools, such as for example a browser, a mailer or a file transfer system, to support their interactions. The interaction system also includes a remote software platform, running on a computer system reachable through either the Internet or through a private network, but the action of such as a remote platform is not visible to the users.

Thanks to the present invention, to allow user A to create a link between a cell/table of spreadsheet S of another user B and a cell/table of one of his/her spreadsheets D it is sufficient that user A (identified for example through his/her email address) is granted the access to that cell/table and not to the entire spreadsheet which the cells/tables belongs to. Furthermore there is no constraint on the fact that the two users belong to the same administrative domain and there is no constraint on the fact that the two spreadsheets S and D belong to the same file management system.

As a consequence the present invention supports advanced collaboration and interaction forms based on links among spreadsheet which are not currently supported.

Such collaboration and interaction forms can be described schematically through the functionalities listed in the following of this document, which are an integral part of the invention. As said above the functionalities are provided by a software platform which is integrated with the Spreadsheet Management System and as a consequence empowers the functionalities of such a system. In the following we call such a software platform the Enabling Platform.

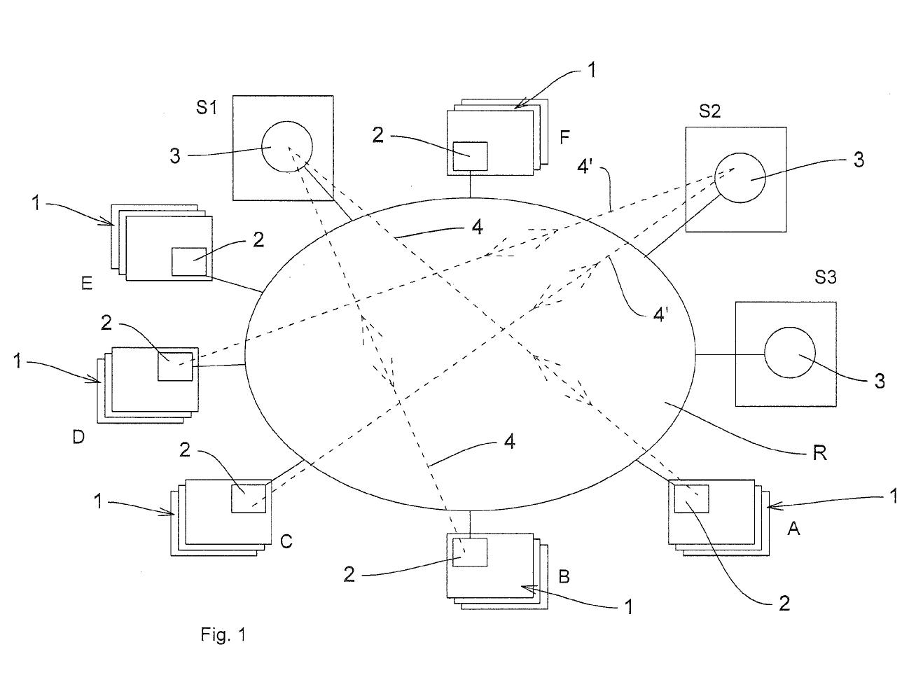

Further objectives and advantages of the current invention will be better detailed in the following description, which is to be considered as an example and not as a limitation and which refers to a schematic drawing in which FIG. 1 shows a scheme of a set of users which have access either to the Internet or to a private network and which can exchange cells and tables through the present system.

With reference to FIGS. 1, A, B, C, D, E and F indicate a set of users with no constraint on localization nor on membership to administrative domains. It is assumed that such users have a Spreadsheet Management System. The present invention consists of the fact that an Enabling Platform 2 allowing, as better explained in the rest of the document, to implement the interaction end the exchange of cells and/or tables among different users is associated to such a Spreadsheet Management System. The scheme also shows some dedicated servers S1, S2 and S3 in which a remote platform called Service Platform is installed. Servers S1, S2 and S3 are connected uniquely with the users of the present system whereas they do not act as Web Servers or Mail Servers.

Users A-F may have access either to the Internet R or to a private network. The dashed lines 4 and 4′ show the actual data paths when two users interact and exchange cells and/or tables: Line 4 is associated to the data flow, and as a consequence to the interaction created between user A and user B through server S1, whereas line 4′ is associated to the data flow and as a consequence to the interaction created, between user C and user D through server S2.

More specifically the Enabling Platform 2 is integrated in the Spreadsheet Management System through the integration technologies made available by the Spreadsheet Management System itself (for example Add-Ins, Apps) and as a consequence resides in the computer system in which the Spreadsheet Management System is running. The Enabling Platform is explicitly used by users A-F, to which it exposes the functionalities described in the following.

The Service Platform 3 resides in a computer system reachable over the network R, that is in one of the servers S1-S3 indicated in the FIGURE, and supports the interaction among the Enabling Platforms 2. The Service Platform is neither visible nor accessible from the users, to which the functionalities are provided by the Enabling Platforms 2, which take advantage of the Service Platform while hiding its presence and operation.

The Enabling Platform 2 is a software system made up of the following subsystems:

1. a subsystem for the activation of the platform functionalities, integrated in the graphical interface of the Spreadsheet Management System, which makes users perceive a complete integration between the Enabling Platform and the Spreadsheet Management System;

2. a subsystem that interacts with the Spreadsheet Management System through the mechanisms that the Spreadsheet Management System makes available;

3. a subsystem that interacts with the Service Platform over the network through an appropriate communication protocol.

The Service Platform 3 is a software system made up of the following subsystems:

1. a subsystem for the management of the software components that interact with the Enabling Platforms through the aforementioned communication protocol;

2. a subsystem for the management of data persistency, based on a database management system, which maintains an up to date copy of the values of the cells/tables managed;

3. a console for the management of the functionalities and of the users.

As said above the system, as a whole, includes a set of functionalities. Such functionalities, listed in the following, are made available by the Enabling Platform 2 to the users A-F.

1. Cell/table Exchange.

2. Creation of links among spreadsheet cells/tables.

3. Provisioning of partially precompiled tables to be filled out.

4. Creation of links based on keys.

5. Provisioning of computing models for utilization only and utilization of such models.

1. Cell/Table Exchange.

The Cell/Table Exchange functionality allows two or more users A-F connected through the network R to exchange cells/tables belonging to their spreadsheets. The innovative value of such a functionality lies in its integration in the Spreadsheet Management System, with an evident advantage for users, who can exchange cells/tables through a reduced number of actions with no need to use external systems such as the electronic mail.

The exchange is concerned with the formats, the styles and the values of the cells/tables as well as, if explicitly requested, with the formulas.

The Cell/Table Exchange functionality is implemented through the forwarding of a cell/table by a user A to a user B or to more users (B, C, . . . ), and through the reception of the same cell/table by the destination user or users.

To send a cell/table user A follows the steps below:

1. He/she selects the cell/table to be sent;

2. He/she activates the Send operation, made available by the Enabling Platform 2 through the graphical interface modality made available by the Spreadsheet Management System;

3. He/she inserts the parameters required for the execution of the Send operation, namely:

a. The destination user or the destination users;

b. The possible indication that the Send operation is concerned with the formulas rather than with the values;

c. A textual description of the cell/table;

4. He/she confirms the command to execute the Send operation: upon such a confirmation the Enabling Platform sends the cell/table to the destination user (or users) through the Service Platform.

To receive a cell/table a user follows the steps below:

1. He/she moves the cursor to the spreadsheet cell in which he/she intends to insert the cell/table;

2. He/she activates the Receive operation provided by the Enabling Platform 2 through the graphical interface made available by the Spreadsheet Management System: upon reception of such activation the Enabling Platform presents the cells/tables sent to the user and as a consequence available to be received by the user; in other words the list of the cells/tables sent to user B is requested to the Service Platform 3 running in server S1 and the Service Platform 3 shows such a list to the user;

3. He/she selects the cells/tables that he/she intend to insert in the point at which the cursor is located among the available cells/tables, as indicated in the initial step.

4. He/she confirms the command to execute the Receive operation: upon reception of such a confirmation the Enabling Platform downloads the selected cell/table from the Service Platform S1 and inserts such a cell/table at the point at which the cursor is located, as indicated in the initial step.

As far as the Cell/Table Exchange functionality is concerned, the Service Platform 3 provides services similar to those of a mail server, that is message send/receive. The distinctive technical characteristics which makes the Cell/Table Exchange functionality different and innovative with respect to the generic send/receive functionality offered by electronic mail is that of being integrated in the Spreadsheet Management System and as a consequence of extending the set of functionalities of such systems.

2. Creation of links among spreadsheet cells/tables.

This functionality allows a user connected to the network:

1. To enable the access to single cells/tables belonging to his/her spreadsheets, and not necessarily to the whole spreadsheets, to other users, with no constraint related to the membership of these users to the same administrative domain and with no constraint related to the membership of the spreadsheet to the same file management system;

2. To create links from cells/tables belonging to spreadsheets of other users to which the user was granted access, with no constraint related to the membership of the users to the same administrative domain and with no constraint related to the membership of the spreadsheets to the same file management system, to cells/tables in his/her spreadsheets.

The connection among the cells/table is unidirectional and is concerned with the formats, the styles and the values.

To enable the access to a cell/table (S) a user follows he steps below:

1. He/she selects the cell/table S;

2. He/she activates the access control functionality, made available by the Enabling Platform 2 through the graphical interface made available by the Spreadsheet Management System;

3. He/she configures the functionality by specifying the following information elements:

a. The users to which the user intends to grant the access to the cell/table S, and

b. a textual description associated to the cell/table S.

4. He/she confirms the command to execute the functionality: upon reception of such a confirmation the Enabling Platform grants the access to the cell/table S to the users indicated while configuring the functionality.

The enablement of the access to a cell/table S can be configured either according to the Manual Updated Modality or according to the Automatic Update Modality:

In the Manual Update Modality the updates to the cell/table S are made available only upon explicit authorization by the user;

In the Automatic Update Modality the updates to the cell/table S are made available automatically and immediately.

To create a link from a cell/table S of another user to a cell/table D of one of his/her spreadsheets a user follows the steps below:

1. He/she moves the cursor to the spreadsheet cell at which it intends to insert the cell/table D in his/her spreadsheet;

2. He/she activates the appropriate functionality made available by the Enabling Platform through the graphical interface made available by the Spreadsheet Management System: upon such an activation the Enabling Platform presents the list of the cells/tables to which the user itself was granted the access;

3. He/she selects the cell/table S from which he intends to create the link to his/her cell/table D;

4. He/she confirms the command to create the link to the Enabling Platform: upon reception of such a confirmation the Enabling Platform creates a link from the cell/table S to the cell/table D, where the link is concerned with formats, the styles and the values of the cells/tables.

The creation of the link has as an effect the activation of a continuous process of alignment of the values of the cell/table D to the values of the cell/table S. More specifically the link from the cell/table S and the cell/table D can be configured by the user who creates the link either in the Manual Alignment Modality or in the Automatic Alignment Modality as described below:

In the case of Manual Alignment Modality the updates of a cell/table S made available are reported on the cell/table D only upon explicit user authorization;

In the case of Automatic Alignment Modality the updates of a cell/table S made available are reported on the cell/table D automatically and immediately.

In summary upon the creation of link from a cell/table S of a user A to a cell/table D of a user B the following four cases may occur:

Case 1: Access Enablement in Manual Modality/Link Creation in Manual Modality—At the update of cell/table S the update of cell/table D takes place only upon explicit authorization by user A and by explicit authorization of user B.

Case 2: Access Enablement in Automatic Modality/Link Creation in Manual Modality—At the update of cell/table S the update of cell/table D takes place only upon explicit authorization of user B.

Case 3: Access Enablement in Manual Modality/Link Creation in Automatic Modality—At the update of cell/table S the update of cell/table D takes place only upon explicit authorization of user A.

Case 4: Access Enablement in Automatic Modality/Link Creation in Automatic Modality—At the update of cell/table S the update of cell/table D takes place immediately with no need of explicit authorization by user A and with no need of explicit authorization by user B.

In the “Creation of links among spreadsheet cells/tables” functionality the Service Platform acts an intermediary between the Enabling Platforms of the users involved. Such a service is necessary because of the two following motivations:

1. The computer systems that host the Enable Platforms may be protected by firewalls and security devices;

2. The users may be not connected to the network at the same time.

To solve these problems the Service Platform:

1. takes advantage of Web Service technology on TCP port 80, thus overcoming the access limitations due to the presence of firewalls, and

2. provides a temporary storage service for cell/tables and for configuration parameters in such a way to support the alignment of two spreadsheets through:

a. the alignment between the Enabling Platform connected to the Spreadsheet Management System which manages the spreadsheet that has granted the access to some of its cells/tables and the Service Platform, and

b. the alignment between the Service Platform and the Enabling Platform connected to the Spreadsheet Management System which manages the spreadsheet that has created the link.

3. Provisioning of partially precompiled tables to be filled out.

The “Provisioning of partially precompiled tables to be filled out” functionality allows spreadsheet users to provide tables which are partially empty, and as a consequence to be filled out, and partially precompiled, to other spreadsheet users, with no constraint on the membership of such users to the same administrative domain and with no constraint on the membership of the spreadsheets in the same file management system. The provisioning of such tables is comparable with the provisioning of preprinted forms to be filled out by the users to which such preprinted forms are provisioned. Some of the cells of the tables are indeed empty and the destination user is supposed to fill them out, whereas other cells are associated to read only values, such as for example the headings, and other cells are associated to formulas that refer to cells internal to the table.

The “Provisioning of partially precompiled tables to be filled out” functionality is made available through two primitive operations respectively called “Provide a partially precompiled Table” and “Receive a partially precompiled Table”, which are respectively activated by the user that provides the partially precompiled table to be filled out and by the user that receives such a partially precompiled table.

The “Provide a partially precompiled Table” operation allows generic user A to provide a partially precompiled table to generic user B, o to a set of users B-F, in such a way that these latter users are able to insert such a table in their spreadsheets through the “Receive a partially precompiled Table” operation. This latter operation allows generic user B to install the precompiled table inside one of his/her spreadsheets and at the same time grants the access to such a table to user A, or possibly to other users if instructed to do so. The installation has the insertion of the table in the spreadsheet of user B as an effect, whereas the enablement of the access allows user B to make the updates to the table deriving from its compilation available to user A or possible to other users.

Upon the termination of the “Receive a partially precompiled Table” operation by user B, user A, or possibly the other users indicated by user B, may activate the “Creation of links among spreadsheet cells/tables” functionality between the table received by user B, the access of which, as indicated in the previous paragraph, was granted to it/them, in such a way to have a copy of the table constantly up to date during its compilation.

In summary the execution of the following three actions in a row (“Provide a partially precompiled Table”, “Receive a partially precompiled Table”, “Creation of a Link by user A or by other users”) results in the creation of a link from user B to user A or to other users having as an object a table corresponding to that provided by user A.

The “Provisioning of partially precompiled tables to be filled out” functionality has the formats, the styles, the values and the formulas contained in the table cells as an object whereas the enablement of the access to the installed tables has the formats, the styles and the values of the table cells as an object.

To activate the “Provide a partially precompiled table” operation user A follows the steps below:

1. He/she selects the table;

2. He/she activates the “Provide a partially precompiled table” operation, made available by the Enabling Platform through the graphical interface made available by the spreadsheet management system;

3. He/she configures the “Provide a partially precompiled table” operation, providing the following information items:

a. The destination user or the destination users, and

b. A textual description of the table;

4. He/she confirms the command to execute the “Provide a partially precompiled tables” operation.

To activate the “Receive a partially precompiled table” operation user A follows the steps below:

1. He/she moves the cursor to the spreadsheet cell in correspondence of which he/she intends to place the partially precompiled table;

2. He/she activate the “Receive a partially precompiled table” operation, made available by the Enabling Platform through its graphical interface: upon such an activation the Enabling Platform connects to the Server Platform and presents the precompiled tables available to be received, that is provided by other users for user B, to user B;

3. He/she selects the table that he/she intends to install;

4. He/she confirms the command to execute the “Receive a partially precompiled table” operation to the Enabling Platform: upon reception of such a confirmation the table selected gets copied in correspondence of the cursor, as indicated in the initial step. The “Receive a partially precompiled table” operation can be configured ether according to the Manual modality according to the Automatic modality. The two modalities differ in the fact that the former modality configures the enablement of the access of the installed table in the Manual Update modality whereas the latter modality configures the enablement of the access of the installed table in the Automatic Update modality.

As far as the “Provisioning of partially precompiled tables to be filled out” functionality is concerned the Service Platform 3 of servers S1-S3 performs a composite service based on the “Cell/Table Exchange” functionality and on the “Provisioning of partially precompiled tables to be filled out” functionality. In particular it supports:

a. The provisioning of the partially precompiled tables;

b. The installation of the partially precompiled tables;

c. The enablement of the access to a precompiled and installed table.

4. Creation of links based on keys.

The “Creation of links based on keys” functionality allows a user connected to a network to link a row of a table S to which he/she was granted the access to a row of one of his/her spreadsheets. The link is not based on the position of the row S in the table whereas it is based on the content of a cell of the row, called Key, in correspondence of a column of the table.

Thanks to this functionality a user can create a link from the row of a table S which he/she can access to a row D of one of his/her spreadsheets by selecting the row of tables S through a value located in correspondence of a given column.

To create a link based on a key from a row of a table S to a row D of one of his/her spreadsheets a user follows the steps below:

1. He/she moves the cursor to the cell of the spreadsheet in correspondence of which he/she intends to insert row D;

2. He/she activates the appropriate functionality made available by the Enabling Platform through the graphical interface made available by the spreadsheet management system: upon the activation of such a functionality the Enabling Platform presents the tables which the user was granted the access to the user;

3. He/she selects among these tables the table S from a row of which he/she intends to create a link to the row D of his/her spreadsheet: upon such a selection the Enabling Platform shows table S to the user;

4. He/she selects, inside table S, the row from which he/she intends to create the link and the column to be used as a key, and implicitly, in this way, the value of the key;

5. He/she confirms the command to create the link to the Enabling Platform: upon the reception of such a confirmation the Enabling Platform creates the link between the two rows, having the formats, the styles and the values of the cells as an object.

The creation of the link has as an effect the activation of a continuous process of alignment of the values of the row of table S having the selected value in the column indicated as a key to the values of row D in the user spreadsheet. As in the previous cases the link from the row of table S and row D can be configured either in the Manual Alignment modality or in the Automatic Alignment modality. The meaning is the same as the one described in the above paragraphs.

As far as the “Creation of links based on keys” functionality is concerned the Service Platform first of all performs the same service it performs when it supports the creation of links to tables to which the user was granted the access. In addition to that it also provides the functionality to select, inside the table with granted access, the rows having a particular value (key) in correspondence of a given column.

5. Provisioning of computing models for utilization only and utilization of such models.

The “Provisioning of computing models for utilization only and utilization of such models” functionality allows spreadsheet users:

1. to make available spreadsheet based computing models to other users for utilization only, without making the computing models, the formulas and the algorithms that these models contain visible, and

2. to use computing models made available by other users without seeing the computing models themselves.

The user who intends make a computing model available for its utilization only must organize the computing model in such a way that it contains:

1. a table P in which the input data to be processed and the configuration parameters needed to perform the computation must be inserted by the users of the computing model;

2. a table R in which the computing model inserts the results of the computation to be made available to the users of the model.

To make a computing model available for its utilization only, a user follows the steps below:

1. He/she opens the spreadsheet that implements the computing model;

2. He/she activates the “Provide a computing model for utilization only” operation;

3. He/she configures the “Provide a computing model for utilization only” operation by indicating the following information elements:

a. The destination user or the destination users,

b. A textual description of the computing model,

c. The position of table P through selection, and

d. The position of table R through selection.

4. He/she confirms the command to execute the “Provide a computing model for utilization only” operation: upon reception of such a confirmation the Enabling Platform activates the operation that provides a partially precompiled table to be filled out for table P and the functionality that enables the access to table R.

To use a computing model made available by another user connected to the network without knowing the internal structure of the model itself a user follows the steps below:

1. He/she activates the functionality related the utilization of a computing model;

2. He/she configures such a functionality by indicating

a. The provider of the computing model,

b. The position of table P, through selection, and

c. The position of table R, through selection.

3. He/she confirms the command to execute the functionality: upon reception of such a confirmation the Enabling Platform activates the functionality to receive a partially precompiled table related to table P and the functionality to enable the access to other users for table R.

As far as the “Provisioning of computing models for utilization only and utilization of such models” functionality is concerned the Service Platform supports the interaction between the user that make the computing model available for utilization only and the user that utilizes such a model through the “Provisioning of partially precompiled tables to be filled out” functionality and through the “Creation of links among spreadsheet cells/tables” functionality.

An exemplary computing system may be used to implement various embodiments of the systems and methods disclosed herein. The computing system may include one or more processors and memory. Main memory stores, in part, instructions and data for execution by a processor to cause the computing system to control the operation of the various elements in the systems described herein to provide the functionality of certain embodiments. Main memory may include a number of memories including a main random access memory (RAM) for storage of instructions and data during program execution and a read only memory (ROM) in which fixed instructions are stored. Main memory may store executable code when in operation. The system further may include a mass storage device, portable storage medium drive(s), output devices, user input devices, a graphics display, and peripheral devices. The components may be connected via a single bus. Alternatively, the components may be connected via multiple buses. The components may be connected through one or more data transport means. Processor unit and main memory may be connected via a local microprocessor bus, and the mass storage device, peripheral device(s), portable storage device, and display system may be connected via one or more input/output (I/O) buses. Mass storage device, which may be implemented with a magnetic disk drive or an optical disk drive, may be a non-volatile storage device for storing data and instructions for use by the processor unit. Mass storage device may store the system software for implementing various embodiments of the disclosed systems and methods for purposes of loading that software into the main memory. Portable storage devices may operate in conjunction with a portable non-volatile storage medium, such as a floppy disk, compact disk or Digital video disc, to input and output data and code to and from the computing system. The system software for implementing various embodiments of the systems and methods disclosed herein may be stored on such a portable medium and input to the computing system via the portable storage device. Input devices may provide a portion of a user interface. Input devices may include an alpha-numeric keypad, such as a keyboard, for inputting alpha-numeric and other information, or a pointing device, such as a mouse, a trackball, stylus, or cursor direction keys. In general, the term input device is intended to include all possible types of devices and ways to input information into the computing system. Additionally, the system may include output devices. Suitable output devices include speakers, printers, network interfaces, and monitors. Display system may include a liquid crystal display (LCD) or other suitable display device.

Display system may receive textual and graphical information, and processes the information for output to the display device. In general, use of the term output device is intended to include all possible types of devices and ways to output information from the computing system to the user or to another machine or computing system. Peripherals may include any type of computer support device to add additional functionality to the computing system. Peripheral device(s) may include a modem or a router or other type of component to provide an interface to a communication network. The communication network may comprise many interconnected computing systems and communication links. The communication links may be wireline links, optical links, wireless links, or any other mechanisms for communication of information. The components contained in the computing system may be those typically found in computing systems that may be suitable for use with embodiments of the systems and methods disclosed herein and are intended to represent a broad category of such computing components that are well known in the art. Thus, the computing system may be a personal computer, hand held computing device, telephone, mobile computing device, workstation, server, minicomputer, mainframe computer, or any other computing device.

Due to the ever changing nature of computers and networks, the description of the computing system is intended only as a specific example for purposes of describing embodiments. Many other configurations of the computing system are possible having more or less components.

The example taken above for the present invention is only an optimal case, which is not limited to the present invention. For technical professionals of the field, the present invention may have various modifications and changes. Any modification, equivalent replacement and renovation made within the concept and principle of the present invention shall be incorporated in the protection range of the present invention.

What is claimed:

1. System for the interaction among spreadsheets (1) connected to a network (R) and belonging to a plurality of users (A-F) which a Spreadsheet Management System (1). The system is characterized by the following:
an Enabling Platform (2), integrated in the Spreadsheet Management System (1) used by the users (A-F), and
a Service Platform (3), installed on a server (S1, S2, S3) connected to a network (R). The service platform interacts with the users (A-F) Enabling Platforms (2);
The Enabling Platforms (2) and the Service Platforms (3) interact and operate in such a way that the interactions among the spreadsheets (1) are activated and controlled by the users only through the Enabling Platform and not using other systems, such as a mailer, a browser or a file transfer system.

2. System according to claim 1, characterized by the fact the Enabling Platform (2) comprises the following subsystems:
a subsystem for the activation of data interchange functions, integrated in the spreadsheet application graphical interface;
a subsystem that interacts with the Spreadsheet Management System by means of the mechanisms provided by the Spreadsheet Management System;
a subsystem that interacts with the Service Platform (3) on the network (R) by means of standard communication protocols and services.

3. System according to claim 1, characterized by the fact the Service Platform (3) comprises the following subsystems:
a subsystem that interacts with the Enabling Platforms (2) by means of standard communication protocols and services;
a subsystem that supports data persistency, based on a Data Base Management System that is updated in real time by users through their Enabling Platforms (2);
a console for the management of functionalities and users.

4. System, according to claim 1, that allows to send/receive cells and/or tables from the spreadsheet of a user (A) to the spreadsheet of another user (B) or more than one user (B, C, D, . . . ) by means of a service integrated in the Enabling Platforms (2) of the users.

5. System, according to claim 1, that allows a user (A) to enable the access to cells, tables or sheets of a spreadsheet to other users (B, C, D, . . . ), without the need for these latter (B, C, D, . . . ) users to belong to the same administrative domain as user A and without the need for the spreadsheet files to belong the same file management system or network file system.

6. System, according to claim 1, that allows a user (A) to create a unidirectional link that originates in a cell, a table, or a sheet of a spreadsheet, to a cell, table or sheet of another spreadsheet, such as every modification in the cell, in a cell of the table, or in a cell of the sheet induces the same modification in the value of the corresponding cell, the corresponding cell of the table, or the corresponding cell of the sheet to which the link is directed. The modification can be propagated directly or after an explicit user command.

7. System, according to claim 1, that allows a user (A) to make available to more than on user (B, C, . . . ) tables created by him/her and partially filled (i.e., including empty cells and non-empty cells, with non-empty cells containing either values or formulas). Recipient users (B, C, . . . ) can receive the partially filled tables, fill the empty cells and grant the access to the resulting table to user (A). Such a functionality supports the distribution/filling of forms in spreadsheet applications.

8. System, according to claim 1, that allows a user (A) to create a link originating from a row in a table to which the same user (A) was granted the access to a target row in a spreadsheet, such that every modification of a cell of such a row induces the same modification on the target row. The originating row is characterized by having a value defined by A in a specific column.

9. System, according to claim 1, that allows a spreadsheet user (A) to make calculation models implemented by means of spreadsheet available to other spreadsheet users (B, C, . . . ) in such a way to:
allow users (B, C, . . . ) to use the calculation models contained and executed in the spreadsheet of user (A) by means of the Spreadsheet Management System, by configuring the model parameters and linking the results of the calculation to spreadsheet cells/tables in a local file, and
allow the users who have created the model not to disclose the model internal structure.
